(19) United States
(12) Patent Application Publication
(10) Pub. No.: US 2015/0330509 A1
(43) Pub. Date: Nov. 19, 2015

(54) Gasket

(71) Applicant: KRAJ Sp. z o. o., Katowice (PL)

(72) Inventor: Jacek Malus, Sosnowiec (PL)

(21) Appl. No.: 14/482,386

(22) Filed: Sep. 10, 2014

(30) Foreign Application Priority Data
May 19, 2014 (PL) W.123094

(51) Int. Cl. F16J 15/08; F16L 23/20

(52) U.S. Cl. CPC F16J 15/0887; F16J 15/0806; F16L 23/20

(57) ABSTRACT

A gasket has a general ring-like shape with an outer diameter and inner diameter and side faces extending therebetween. The gasket has an inner portion extending radially outward from the inner diameter on at least one side face that is grooved. The gasket has an outer portion surrounding the inner portion. The inner portion is angled relative to the outer portion. Each side face may have an inner portion extending radially outward from the inner diameter. The outer portion may be flat. The inner diameter may be axially offset from the outer diameter by about 1 mm. The inner portion may comprise a coating over the grooves. The inner portion and the outer portion may be monolithically formed.

### RELATED APPLICATION DATA

This application claims priority to Polish patent application serial no. W.123094 [WIPO ST 10/C PL123094U] filed May 19, 2014, the disclosure of which is incorporated by reference herein.

### BACKGROUND AND SUMMARY

The disclosure relates generally to gaskets and, more particularly, to an improved gasket for positioning between opposing facing flanges of piping systems or conduits. These facing flanges are bolted together with the gasket disposed therebetween. The bolted connection may experience relaxation and load loss after initial tightening. The gasket disclosed herein recovers and compensates for this load loss under a variety of conditions.

### BRIEF DESCRIPTION OF THE DRAWINGS

FIG. 1 is a top plan view of an exemplary embodiment of a gasket.

FIG. 2 is a side cross sectional view of the gasket of FIG. 1 in an application involving opposing facing flanges having a bolted connection.

FIG. 3 is an enlarged view of detail area 3-3 of FIG. 2.

FIG. 4 is a schematic diagram of the gasket of FIG. 1 showing contact points with opposed facing flanges of the type shown in FIG. 2.

FIG. 5 is a schematic diagram of the gasket of FIG. 1 compressed and loaded between opposed facing flanges of the type shown in FIG. 2.

FIG. 6 is a schematic diagram of the gasket of FIG. 1 showing the force distribution pattern exerted by the gasket of FIG. 1 compressed and loaded between opposed facing flanges of the type shown in FIG. 2.

FIG. 7 is a chart comparing the compressibility and elastic recovery of a conventional kammprofile gasket and the gasket described herein.

FIG. 8 is a table comparing characteristics of a conventional kammprofile gasket and the gasket described herein.

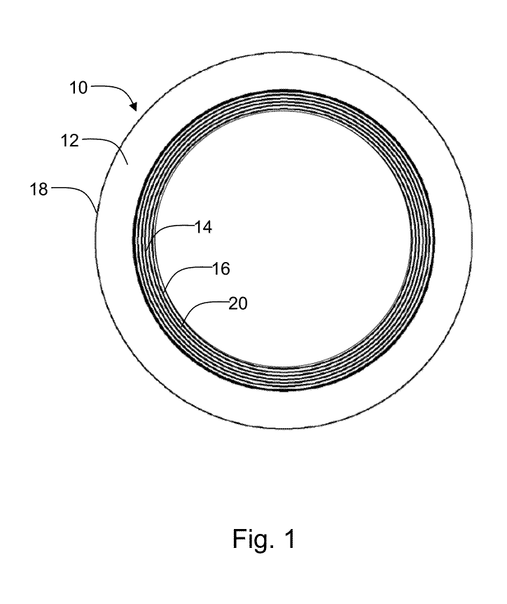

### DETAILED DESCRIPTION

The exemplary gasket 10 has an annular shape with an outer ring portion 12 surrounding an inner ring portion 14. The inner ring portion 14 may extend radially outward from an inner diameter 16 of the gasket and may form a portion of the side face of the gasket. The outer ring portion 12 may extend radially inward from an outer diameter 18 of the gasket and may form another portion of the side face of the gasket, which may be visually different from the inner ring portion. The side faces of the gasket seal against the flanges of the bolted connection. The inner ring portion 14 and outer ring portion 12 may be monolithically formed. In a monolithic configuration as shown, the gasket may comprise a solid metal core. The inner ring portion and the outer ring portion may also be separable members that become integrally connected upon assembly. The inner ring portion 14 may have a plurality of grooves 20 on a face of the gasket. The grooves 20 may be provided on both faces of the gasket. The grooves 20 may be serrated or have other shapes. The grooves 20 may be machined or otherwise formed (i.e., coined) in the inner ring portion. The grooves may be uniformly sized and shaped and may be equally-spaced apart (i.e., concentric). The grooves 20 may hold graphite, PTFE, or other soft conformable facing or coating 22. The gasket may be formed with an amount of camber 24 on at least a portion of the inner ring portion 14. The amount of camber 24 may be set dimension, for instance, 1 millimeter, regardless of the size of the gasket. The amount of camber may also be specified in terms of an angle 26. The angle may 0.5 degrees to 45 degrees. The camber in the gasket provides the gasket with a dish-shaped cross-section.

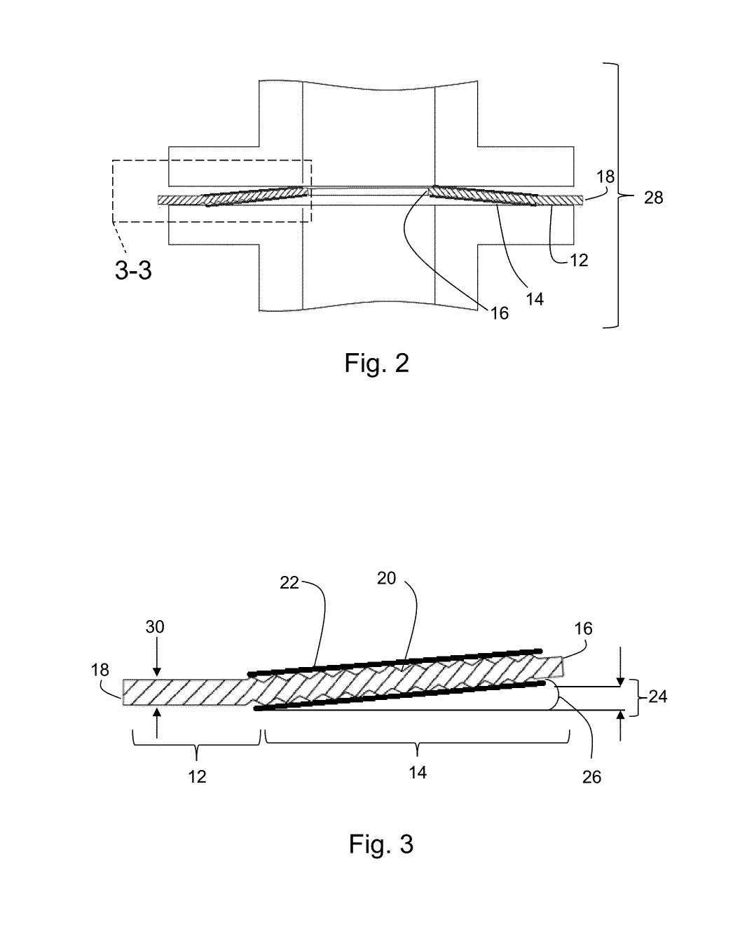

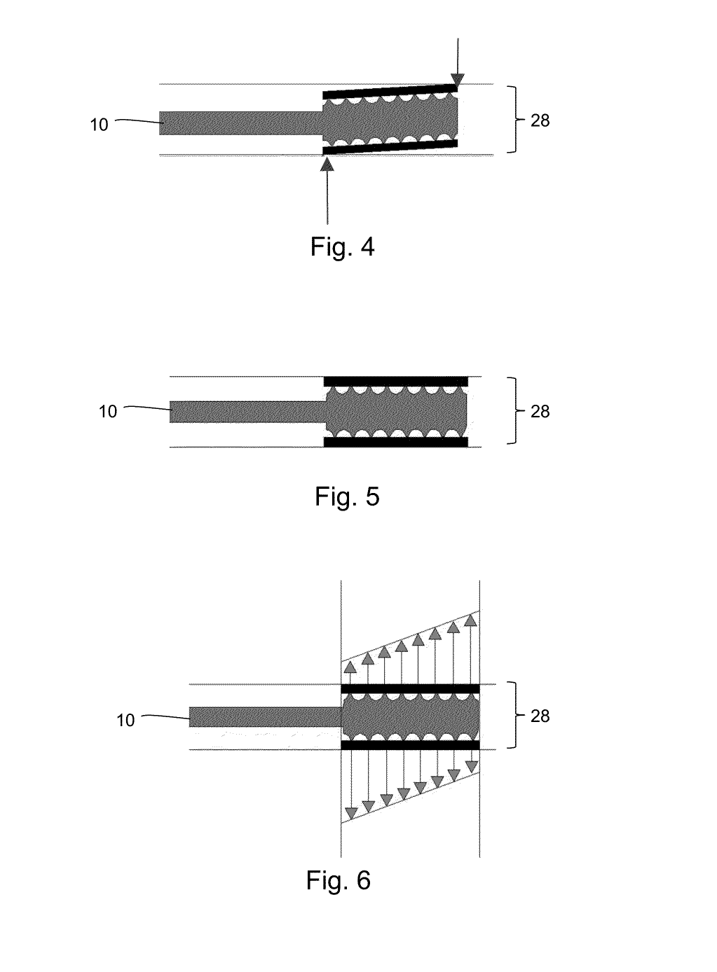

Providing a camber 24,26 in the gasket provides several advantages when compared to a conventional kammprofile gasket. In one aspect, the camber 24,26 in the gasket allows for improved compensation for the effects of creep relaxation of the bolted connection 28 (FIG. 2). In another aspect, the camber 24,26 in the gasket allows for improved compensation for temperature and pressure variation of the piping system, and vibrations of the piping system across the bolted connection 28. Providing camber in the gasket allows for increased compressibility of the gasket which allow for greater elastic recovery for the gasket under a variety of transient and operating conditions. Further, providing a camber in the gasket allows for two point contact of the gasket at the beginning of installation as shown in FIG. 4. One edge of the inner ring portion is shaped to contact one flange and an opposite face of the gasket is shaped to contact the facing flange. Thus, the gasket may be aligned with low tension on the bolts of the bolted connection, which may obviate the need for an alignment handle on the gasket. The gasket may also seal with low tension on the bolts of the bolted connection, which may reduce the results of creep of the bolted connection 28. Providing an inner ring portion with camber has been found to aid in maintaining critical gasket stress to improve sealing across the bolted connection as shown schematically in FIG. 5. The camber of the gasket also provides a desired pressure distribution pattern across each flange of the bolted connection 28 as shown schematically in FIG. 6. The gradient type pressure pattern across the gasket and flange may provide sufficient sealing at very low stress. Sealing may be greatest where the pressure in the pressure distribution pattern is highest. The camber in the gasket allows the gasket to compensate for misalignment and flange parallelism issues as well as increase the ability to seal imperfect connections.

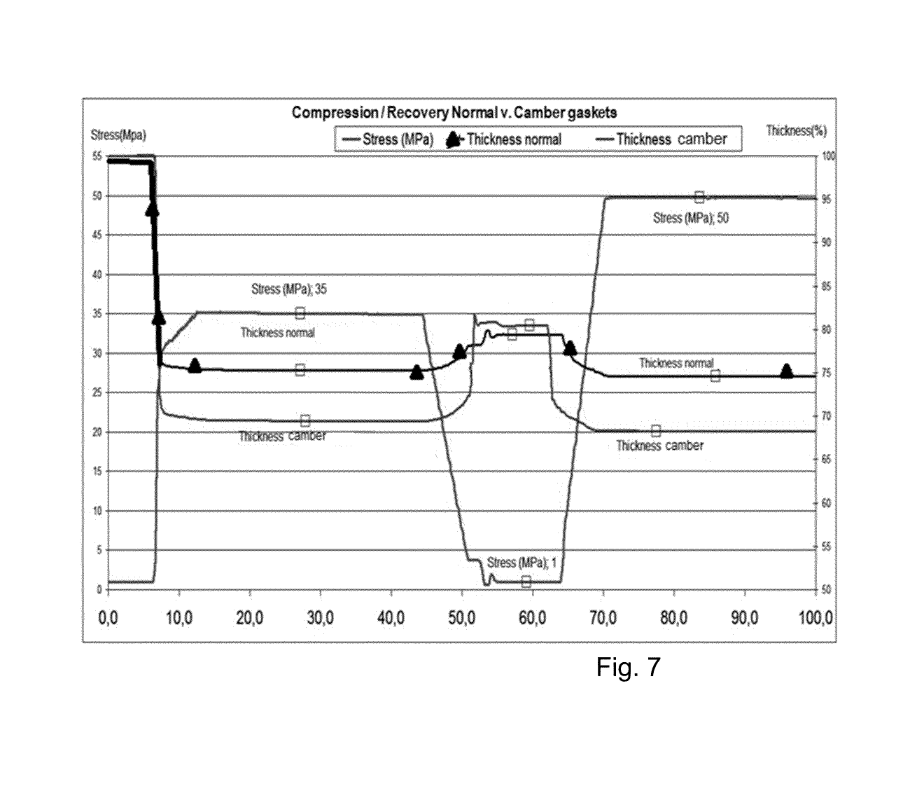

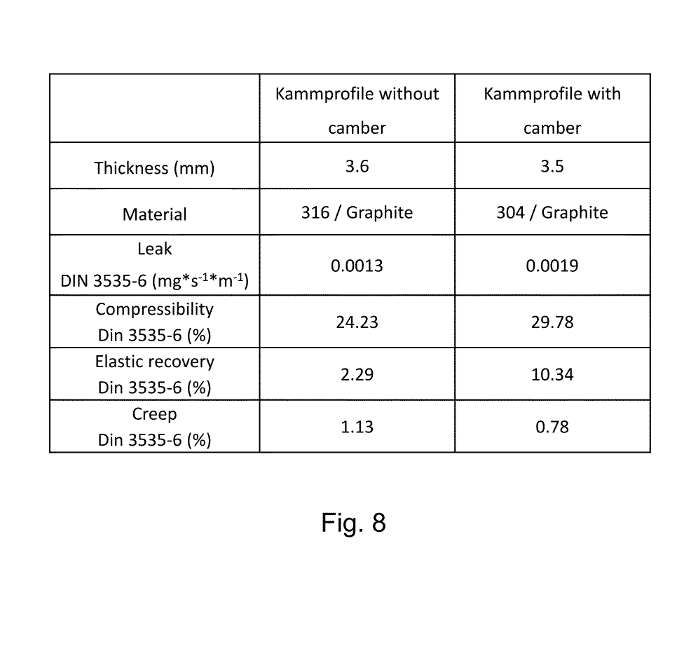

The amount of camber 24,26 may be selected as desired to change any of the aforementioned characteristics. The thickness 30 of the gasket may also be altered as desired in combination with the amount of camber 24,26 to change any of the aforementioned characteristics. A graph of recovery from compression from a pressure transient comparing a normal kammprofile type gasket with a camber gasket is shown in FIG. 7. The camber gasket maintains compressibility during the transients better than the normal kammprofile gasket. FIG. 8 provides a comparison of similar information in chart form.

The core of the gasket 10 may be formed as desired based in part on the intended application, and the amount of camber 24,26 may be provided when forming the core, the grooves, or thereafter, as desired. In one aspect, the amount of camber 24,26 may be machined directed into the gasket when forming the grooves of the inner ring portion. For instance, the core may be formed by machining a bar stock or plate material into a ring form for the core blank. Wire or strip material may also be used by forming into a ring form and then welding the ends to form a continuous, annular ring form. The ring form may be next mounted on a lathe where the groove and camber profile may be machined directly to form the core. The desired groove and camber geometry may also be formed on the ring form by means of a milling operation. The grooves may also be formed by a compression die or by a roll forming process. The annular ring shape of the core blank may be initially machined from a selected raw material stock with an initial size based on the specific application. The sizes may also be specified by commercial or industry standards based upon the nominal pipe size (“NPS”) and the classification associated with the flanges based upon system pressure. For instance, in an application involving a 4 inch NPS, the inner diameter of the gasket may be 4⅞ inches and inner ring groove portion may be 19/32 inches. Depending upon the flange class, the outer diameter of the gasket may 6⅞ inches (150 class), 7⅛0 inches (300 class), 7 inches (400 class), 7⅝ inches (600 class), 8⅛ inches (900 class), 8¼ inches (1500 class) and 9¼ inches (2500 class). The camber may be 0.039 inches (1 mm) for each size. Machining the groove and camber geometry into the core may assist in achieving any of the aforementioned characteristics. In the alternative, the gasket may be assembleable to achieve the desired camber of the inner ring portion relative to the outer ring portion.

In view of the foregoing, it will be seen that the several advantages are achieved and attained. The embodiments were chosen and described in order to best explain the principles and their practical application to thereby enable others skilled in the art to best utilize the various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A gasket having a general ring-like shape with an outer diameter and inner diameter and side faces extending therebetween, the gasket having an inner portion extending radially outward from the inner diameter on at least one side face, the gasket having an outer portion surrounding the inner portion, the inner portion having grooves, the inner portion being angled relative to the outer portion.

2. The gasket of claim 1 wherein each side face has an inner portion extending radially outward from the inner diameter.

3. The gasket of claim 1 wherein the outer portion is generally flat.

4. The gasket of claim 1 wherein the inner diameter is axially offset from the outer diameter by about 1 mm.

5. The gasket of claim 1 wherein the inner portion comprises a coating over the grooves.

6. The gasket of claim 1 wherein the inner portion and the outer portion are monolithically formed.

7. The gasket of claim 1 wherein the amount of angle is selected to provide the gasket with a desired stiffness characteristic.

8. The gasket of claim 7 wherein a thickness of the gasket is selected to provide the gasket with a desired stiffness characteristic.

9. A gasket configured to be disposed between flanges of a piping system, the gasket having a dish shape and with side faces configured to seal the connection between the flanges of the piping system.

10. The gasket of claim 9 wherein the gasket has an inner diameter with a plurality of grooves extending radially outward from the inner diameter along a side face of the gasket.

11. The gasket of claim 10 wherein each side face of the gasket has a plurality of grooves extending radially outward from the inner diameter.

12. The gasket of claim 11 wherein the gasket has a flat outer ring portion that extends from an outer diameter of the gasket radially inward.

13. The gasket of claim 12 wherein the inner ring portion is angled relative to the outer ring portion in a manner to provide the gasket with the dish shape.

14. The gasket of claim 12 wherein the amount of angle is selected to provide the gasket with a desired stiffness characteristic.

15. The gasket of claim 14 wherein a thickness of the gasket is selected to provide the gasket with a desired stiffness characteristic.

16. The gasket of claim 13 wherein the inner ring portion and the outer ring portion are monolithically formed.

17. An annular gasket configured to be disposed between flanges of a piping system, the gasket having side faces configured to seal the connection between the flanges of the piping system, a portion of the side faces being cambered.

18. The gasket of claim 17 wherein the cambered portion of at least one gasket side face has a plurality of grooves extending radially outward from the inner diameter.

19. The gasket of claim 17 wherein the gasket has a flat outer ring portion that extends radially outward from the cambered portion.

20. The gasket of claim 17 wherein an inner diameter of the gasket is axially offset from an outer diameter of the gasket by about 1 mm.

21. The gasket of claim 17 wherein the cambered portion of gasket is monolithically formed with the remainder of the gasket.

22. The gasket of claim 17 wherein a thickness of the gasket is selected to provide the gasket with a desired stiffness characteristic.

23. The gasket of claim 22 wherein the amount of camber is selected to provide the gasket with a desired stiffness characteristic.
